(19) United States
(12) Patent Application Publication
(10) Pub. No.: US 2026/0011502 A1
(43) Pub. Date: Jan. 8, 2026

(54) LAMINATED CERAMIC ELECTRONIC COMPONENT

(71) Applicant: Murata Manufacturing Co., Ltd., Nagaokakyo-shi (JP)

(72) Inventor: Tomoki KITAGAWA, Nagaokakyo-shi (JP)

(21) Appl. No.: 19/324,328

(22) Filed: Sep. 10, 2025

Related U.S. Application Data
(63) Continuation of application No. PCT/JP2024/000952, filed on Jan. 16, 2024.

(30) Foreign Application Priority Data
Mar. 30, 2023 (JP) 2023-055773

(51) Int. Cl. H01G 4/30; H01G 4/232

(52) U.S. Cl. CPC H01G 4/30; H01G 4/232

(57) ABSTRACT

A multilayer ceramic electronic component includes a capacitor body including dielectric layers and internal electrode layers alternately laminated, and two external electrodes respectively on two end surfaces, connected to the internal electrode layers, and covering a portion of a main surface and a portion of a side surface, two spacers respectively on one end surface side and an other end surface side, with the external electrode covering the portion of the main surface or the portion of the side surface being sandwiched therebetween, at a main surface side or a side surface side of the capacitor body, and a reinforcement portion between the two spacers. The reinforcement portion covers about 50% or more of a center-side spacer end surface, where the two spacers face each other, and of two spacer end surfaces facing each other in a length direction in each of the two spacers.

### CROSS REFERENCE TO RELATED APPLICATIONS

This application claims the benefit of priority to Japanese Patent Application No. 2023-055773 filed on Mar. 30, 2023 and is a Continuation Application of PCT Application No. PCT/JP2024/000952 filed on Jan. 16, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic electronic components such as multilayer ceramic capacitors are widely used in various electronic devices such as mobile terminal devices including mobile phones and personal computers. Such multilayer ceramic capacitors each include a rectangular parallelepiped-shaped multilayer body in which dielectric layers and internal electrode layers are alternately laminated, and external electrodes provided at both opposing ends of the multilayer body.

The multilayer ceramic capacitors each include an inner layer portion in which the dielectric layers and the internal electrodes are alternately laminated. Then, dielectric layers defining and functioning as outer layer portions are provided at the top and bottom of the inner layer portion to form a rectangular parallelepiped-shaped multilayer body, and external electrodes are provided on both end surfaces in the longitudinal direction of the multilayer body to form a capacitor main body.

Furthermore, in order to suppress the occurrence of “acoustic noise”, multilayer ceramic capacitors have been known, each including a spacer that covers a portion of the external electrode on a side of the capacitor main body to be mounted on a substrate (see, for Japanese example, Unexamined Patent Application, Publication No. 2015-216337).

However, when the bonding strength between the capacitor main body and the spacer is weak, the spacer may peel off, and thus is not sufficient in terms of durability when mounted.

### SUMMARY OF THE INVENTION

Example embodiments of the present invention provide multilayer ceramic capacitors each with high bonding strength between a capacitor main body and a spacer, and each with excellent durability when mounted.

A multilayer ceramic electronic component according to an example embodiment of the present invention includes a capacitor main body including a multilayer body including dielectric layers and internal electrode layers alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction, and two external electrodes each on a corresponding one of the two end surfaces, each connected to the internal electrode layers, and each extending to the two main surfaces and the two lateral surfaces to cover a portion of each of the two main surfaces and a portion of each of the two lateral surfaces, two spacers on one of the two main surfaces or one of the two lateral surfaces of the capacitor main body, and respectively adjacent to one of the two end surfaces and adjacent to an other of the two end surfaces with a corresponding one of the two external electrodes covering the portion of each of the two main surfaces or the portion of each of the two lateral surfaces interposed between the capacitor main body and a corresponding one of the two spacers, and a reinforcement portion between the two spacers, in which the reinforcement portion covers about 50% or more of middle-side spacer end surfaces of the two spacers opposed to each other between the two spacers, among two spacer end surfaces opposed to each other in the length direction in each of the two spacers.

According to example embodiments of the present invention, multilayer ceramic capacitors each with high bonding strength between a capacitor main body and a spacer, and each with excellent durability when mounted are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along the line II-II in FIG. 1 of the multilayer ceramic capacitor 1.

FIG. 3 is a cross-sectional view taken along the line III-III in FIG. 1 of the multilayer ceramic capacitor 1.

FIG. 4 is an enlarged view of a portion of a spacer 4 in the cross-sectional view of the multilayer ceramic capacitor 1 shown in FIG. 2.

FIG. 5 is a flowchart explaining a manufacturing method of the multilayer ceramic capacitor 1 according to an example embodiment of the present invention.

FIGS. 6A to 6D are diagrams explaining a multilayer body manufacturing step S1 and an external electrode formation step S2.

FIGS. 7A to 7C are diagrams explaining a spacer placement step S3.

FIGS. 8A and 8B are diagrams explaining a reinforcement portion placement step S4.

### DETAILED DESCRIPTION OF EXAMPLE EMBODIMENTS

Example embodiments of the present invention will be described in detail below with reference to the drawings.

In the following, a multilayer ceramic capacitor 1 will be described as an example of a multilayer ceramic electronic component according to an example embodiment of the present invention, but the present invention is not limited thereto. Also, the drawings may be schematically simplified to explain the content of the present invention, and the ratio of dimensions of the components or between components depicted may not match the ratio of their dimensions described in the specification. Also, components described in the specification may be omitted in the drawings, or the number of components may be reduced in the drawings.

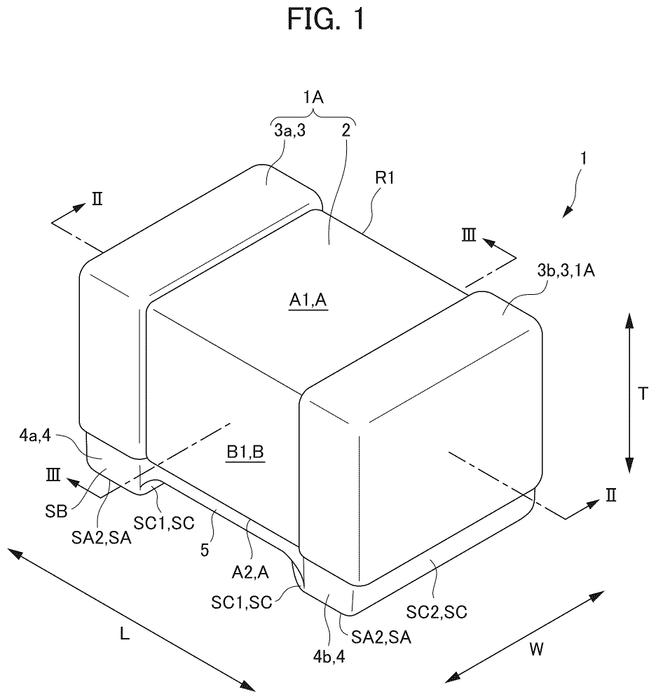

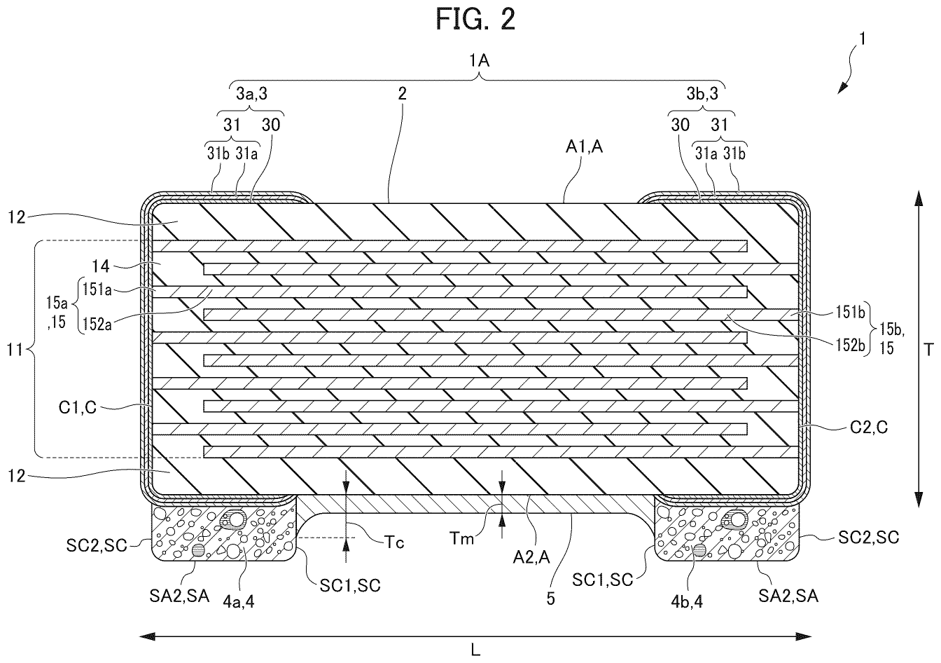

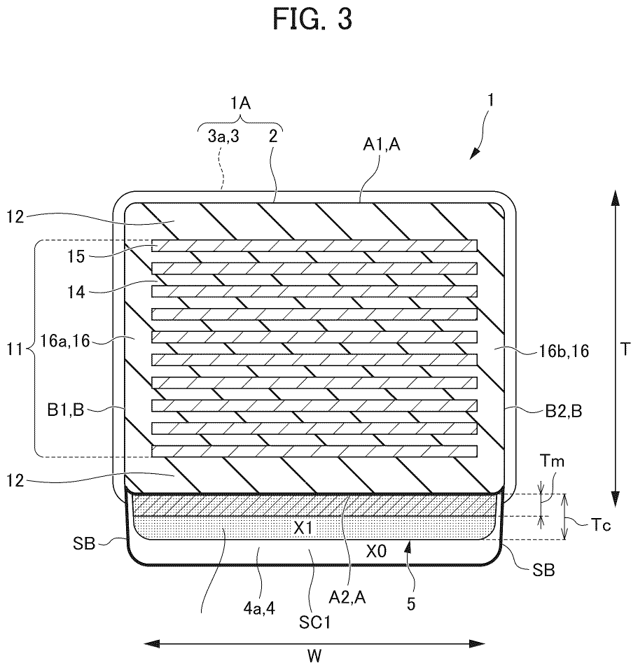

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to the present example embodiment. FIG. 3 is a cross-sectional view taken along the line III-III in FIG. 1 of the multilayer ceramic capacitor 1 according to the present example embodiment.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, spacers 4 attached to the capacitor main body 1A, and a reinforcement portion 5 provided between the two spacers 4.

The multilayer body 2 includes an inner layer portion 11 including dielectric layers 14 and internal electrode layers 15 laminated together.

In the following description, as a term representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are stacked (or laminated) is defined as the stacking or lamination direction T. The direction intersecting both the length direction L and the lamination direction T is defined as the width direction W. In addition, in the present example embodiment, the width direction W is orthogonal or substantially orthogonal to both the length direction L and the lamination direction T.

### Outer Surface of Multilayer Body 2

Among the six outer surfaces of the multilayer body 2, a pair of outer surfaces opposed to each other in the lamination direction T are defined as a first main surface A1 and a second main surface A2, a pair of outer surfaces opposed to each other in the width direction W are defined as a first lateral surface B1 and a second lateral surface B2, and a pair of outer surfaces opposed to each other in the length direction L are defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably has rounded ridge portions R1 including corner portions. The ridge portions R1 are portions where two surfaces of the multilayer body 2, i.e., the main surface A and the lateral surface B, the main surface A and the end surface C, or the lateral surface B and the end surface C, intersect.

### Multilayer Body 2

The multilayer body 2 includes an inner layer portion 11 that generates capacitance, outer layer portions 12 that sandwich the inner layer portion 11 from the lamination direction T, and side gap portions 16 that sandwich the inner layer portion 11 and the outer layer portions 12 from the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 are each made of a ceramic material. As the ceramic material, for example, a dielectric ceramic with BaTi03 as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1 and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of each of the first internal electrode layers 15a and the second counter portion 152b of each of the second internal electrode layers 15b.

The internal electrode layers 15 are preferably made of a metal material such as, for example, nickel (Ni), copper (Cu), silver (Ag), palladium (Pd), silver-palladium (Ag-Pd) alloy, gold (Au), etc.

### Outer Layer Portion 12

The outer layer portion 12 can be made of the same material as the dielectric layers 14 of the inner layer portion 11.

### Side Gap Portion 16

The side gap portions 16 sandwich the inner layer portion 11 and the outer layer portion 12 from the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portions 16 can be made of the same material as the dielectric layer 14.

### External Electrode 3

The external electrodes 3 include a first external electrode 3a provided on the first end surface C1, and a second external electrode 3b provided on the second end surface C2. The external electrodes 3 cover not only the end surface C, but also a portion of the main surface A and a portion of the lateral surface B continuous with the end surface C.

As described above, the end portion of the first extension portion 151a of each of the first internal electrode layers 15a is exposed at the first end surface C1 and electrically connected to the first external electrode 3a. Furthermore, the end portion of the second extension portion 151b of each of the second internal electrode layers 15b is exposed at the second end surface C2, and is electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a plated layer 31. However, it is not necessarily required that the external electrodes 3 include such a layered configuration.

The base electrode layer 30 is formed, for example, by applying and firing an electrically conductive paste including copper (Cu). The base electrode layer 30 may also include glass and ceramic material. The configuration of the base electrode layer 30 is not limited thereto.

The plated layer 31 includes, for example, a nickel (Ni) plated layer 31a provided on the surface of the base electrode layer 30, and a tin (Sn) plated layer 31b provided on the surface of the nickel (Ni) plated layer 31a. The configuration of the plated layer 31 is not limited thereto.

### Spacer 4

The spacers 4 include a pair of a first spacer 4a and a second spacer 4b. The first spacer 4a is provided on the second main surface A2, which is a substrate mounting surface of the capacitor main body 1A, and adjacent to the end surface C1 located on one side in the length direction L. The second spacer 4b is provided on the second main surface A2 and adjacent to the end surface C2 located on the other side in the length direction L. Each spacer 4 connects with a portion of the external electrode 3 provided on the second main surface A2. When the substrate mounting surface of the capacitor main body 1A is the first lateral surface B1, the first spacer 4a is provided on the first lateral surface B1, which is a substrate mounting surface of the capacitor main body 1A, and adjacent to the end surface C1 located on one side in the length direction L. The second spacer 4b is provided on the first lateral surface B1 and adjacent to the end surface C2 located on the other side in the length direction L.

In the following, in each spacer 4, the two surfaces that are opposed to each other in the lamination direction T are defined as spacer main surfaces SA, the two surfaces that are opposed to each other in the length direction L are defined as spacer end surfaces SC, and the two surfaces that are opposed to each other in the width direction W are defined as spacer lateral surfaces SB.

In addition, among the two spacer end surfaces SC, a spacer end surface SC adjacent to the middle portion in the length direction L of the capacitor main body 1A is defined as a middle-side spacer end surface SC1, and a spacer end surface SC on the outer side in the length direction L of the multilayer body 2 is defined as an outer side spacer end surface SC2.

Among the two spacer main surfaces SA, the spacer main surface SA adjacent to the capacitor main body 1A is defined as the main body-side spacer main surface SA1, and the spacer main surface SA on the other side is defined as the mounting side spacer main surface SA2. When the substrate mounting surface of the capacitor main body 1A is the first lateral surface B1, among the two spacer lateral surfaces SB, the spacer lateral surface SB adjacent to the capacitor main body 1A is defined as the main body-side spacer lateral surface SB1, and the spacer lateral surface SB on the other side is defined as the mounting side spacer main surface SB2.

In the present example embodiment, the external electrodes 3 each include the base electrode layer 30 and the plated layer 31 that covers the base electrode layer 30, and each spacer 4 is provided on the surface of the plated layer 31. However, for example, each spacer 4 may be provided on the surface of the base electrode layer 30, and a second plated layer may cover each spacer 4 and the base electrode layer 30. By providing the second plated layer, the bonding strength between each spacer 4 and the base electrode layer 30 is improved.

### Material of Spacer 4

Each spacer 4 includes, for example, either copper (Cu) or nickel (Ni) as metal powder, and tin (Sn). The copper (Cu) and nickel (Ni) may be coated with silver (Ag). In addition, each spacer 4 may further include, for example, silver (Ag) as a metal constituting an intermetallic compound.

The intermetallic compound formed by adding tin (Sn) to either copper (Cu) or nickel (Ni) has a melting point that does not melt even when soldering is performed upon mounting the multilayer ceramic capacitor 1 on a wiring board, and no deformation due to heat occurs. Therefore, the shape of each spacer 4 can be reliably maintained, and it is possible to provide each spacer 4 while maintaining the desired form even during soldering. In particular, for example, an intermetallic compound formed by adding tin (Sn) to an alloy of copper (Cu) and nickel (Ni) is preferable as a component for forming each spacer 4.

The metal region MP made by the metal powder may include phenol resin, for example. The phenol resin coats the intermetallic compound particles and is scattered to fill the gaps between the particles.

The phenol resin not completely coat the intermetallic compound particles. In addition, by using phenol resin, the amount of gas generated during the heating treatment when forming each spacer 4 can be reduced, thus reducing voids in each spacer 4. The phenol resin may be exposed on the surface of each spacer 4 and cover at least a portion of the surface of each spacer 4. By covering the surface of each spacer 4 with phenol resin, the smoothness of the surface of each spacer 4 is improved, and the mechanical strength of each spacer 4 can be increased.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, polyoxystyrenes such as polyparaoxystyrene, or the like.

The area ratio of phenol resin in each spacer 4 is, for example, preferably about 1% or more and about 20% or less, and particularly preferably about 5% or more and about 15% or less, in the LT cross-section perpendicular or substantially perpendicular to the width direction W of each spacer 4. When it is less than about 18, the effect of the phenol resin cannot be sufficiently exhibited, and when it exceeds about 208, there is a risk that the bonding strength of each spacer to the external electrode will decrease.

As a method for determining the area ratio (%) of phenol resin in each spacer 4, for example, one spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the resin region RP, and from the areas of the metal region MP, metal powder MF, resin region RP, and void P, the area ratio (%) of phenol resin can be calculated by the formula: (area ratio (%) of phenol resin)=(area of resin region RP)/(area of metal region MP+area of metal powder MF+area of resin region RP+area of void P)×100.

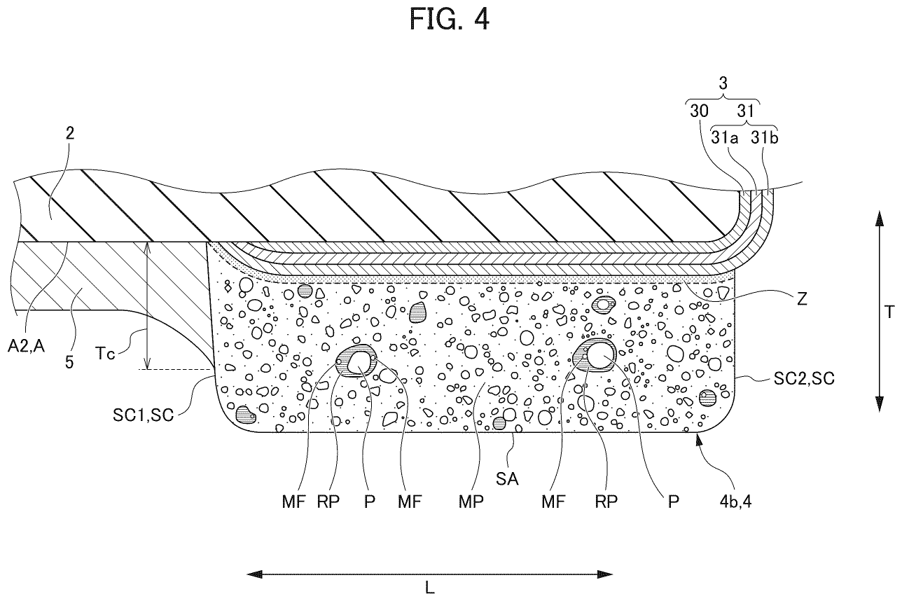

FIG. 4 is an enlarged view of a portion of one of the spacers 4 in the cross-sectional view of the multilayer ceramic capacitor 1 shown in FIG. 2. As shown in FIG. 4, the resin region RP including phenol resin may include metal powder MF. The metal powder MF reduces or prevents the shrinkage of the phenol resin, and can relax the compressive stress due to the phenol resin.

The spacer 4 preferably has a void ratio of, about 20% or less in the region Z within about 5 μm from the interface with a corresponding one of the external electrodes 3. By keeping the void ratio low, the bonding area of the spacer 4 that bonds with the external electrode 3 increases, thus improving the bonding strength with the external electrode 3.

Inside the spacer 4, voids P are provided, and the maximum diameter of the voids P is, for example, preferably about ½ or less of the maximum dimension in the thickness of the spacer 4 in the lamination direction T. If it exceeds about ½, cracks are likely to occur with the voids P as starting points, reducing the strength of the spacer 4. When the substrate mounting surface of the capacitor main body 1A is the first lateral surface B1, the maximum diameter of the voids P formed inside the spacer 4 is, for example, preferably about ½ or less of the maximum dimension in the thickness of the spacer 4 in the width direction W.

As a method for determining the void ratio (%), for example, the spacer 4 is polished in the width direction W to the middle position in the width direction W, and the polished surface is magnified about 50 times with a microscope (BX-51) and photographed with a digital camera for microscopes (DP22manufactured by Olympus). The obtained image is binarized to separate the metal region MP and the void P portions, and the void ratio (%) can be calculated by the formula: void ratio (%)=(area of void P)/(area of metal region MP+area of metal powder MF+area of resin region RP+area of void P)×100, from the respective areas of the metal region MP, metal powder MF, resin region RP, and void P.

In the above, a configuration including metal intermetallic compounds and phenol resin is shown as an example of the spacer material, but the present invention is not limited thereto, and may include different types of metal components, or may include resins other than the phenol resin such as an epoxy resin and rosin, and/or a glass component. Also, it may be formed without including resin. It may be manufactured with a material, for example, including copper or copper alloy, and provided to be connected via Ni plating and solder.

When the spacer 4 is smaller than the external electrode 3 in a plan view from the direction connecting the surface to which the spacer 4 is applied and the surface opposed to that surface, it is preferable to provide a direction identification mark to at least a portion of the spacer 4. The direction identification mark indicates the direction for opposing the second main surface A2 or the first lateral surface B1 where the spacer 4 is provided toward the wiring board when mounting the multilayer ceramic capacitor 1 on the wiring board, and can include coloring the spacer 4 with a color different from the external electrode 3, printing a direction identification mark such as a QR code (registered trademark) for identifying the direction, or providing a recessed portion in a portion of the multilayer body. As a coloring, the phenol resin included in the spacer 4 may be exposed on the surface of the spacer 4 to have a color different from the external electrode 3. Also, the direction identification mark may be provided on the multilayer body 2, not limited to the spacer 4. Even when the spacer 4 is larger than the external electrode 3, a direction identification mark may be provided.

For example, when the color tones of the spacer 4 and the external electrode 3 are similar to each other, it may not be possible to determine which side has the surface to which the spacer 4 is applied when viewed from above, potentially causing image processing errors. However, by providing a direction identification mark, such image processing errors can be prevented.

### Reinforcement Portion 5

As shown in FIG. 1, the reinforcement portion 5 is provided between the two spacers 4 to cover the second main surface side of the capacitor main body 1A. When the substrate mounting surface of the capacitor main body 1A is the first lateral surface B1, it is provided between the two spacers 4 to cover the first lateral surface side of the capacitor main body 1A.

### Material of Reinforcement Portion 5

The reinforcement portion 5 includes an insulating resin, and in the present example embodiment, for example, the reinforcement portion 5 is mainly made of insulating resin. The surface of the insulating resin may be coated with a water-repellent treatment agent. By forming the reinforcement portion 5 with an insulating resin, the bending strength is improved, and by coating it with a water-repellent treatment agent, the moisture resistance is further improved. The insulating resin may include, for example, ceramics, glass, etc. Also, the reinforcement portion 5 preferably has higher bonding strength with the multilayer body 2 than metal intermetallic compounds. For example, the reinforcement portion 5 may include epoxy resin as a main component, combined with phenol resin as a curing agent. As other curing agents, for example, a curing agent of an acid anhydride system, amine system, ester system or the like can be used. A curing accelerator may also be added to the epoxy resin, for example. It may also include a water-repellent treatment agent.

### Shape of Reinforcement Portion 5

As shown in FIG. 2, the reinforcement portion 5 is continuously provided in the length direction L between the middle-side spacer end surface SC1 of one spacer 4 and the middle-side spacer end surface SC1 of the other spacer 4, and covers the second main surface A2 of the capacitor main body 1A (multilayer body 2) and each of the middle-side spacer end surfaces SC1 of the two spacers 4. When the substrate mounting surface of the capacitor main body 1A is the first lateral surface B1, it covers the first lateral surface B1 of the capacitor main body 1A (multilayer body 2) and each of the middle-side spacer end surfaces SC1 of the two spacers 4.

However, the reinforcement portion 5 does not need to be continuous between the first spacer 4a and the second spacer 4b. The reinforcement portion 5 may be provided discontinuously by dividing it into one portion covering the middle-side spacer end surface SC1 of the first spacer 4a and a portion of the second main surface A2 of the capacitor main body 1A (multilayer body 2), and another portion covering the middle-side spacer end surface SC1 of the second spacer 4b and a portion of the second main surface A2 of the capacitor main body 1A (multilayer body 2). In a case where the substrate mounting surface of the capacitor main body 1A is the first lateral surface B1, the reinforcement portion 5 may be provided discontinuously by dividing it into one portion covering the middle-side spacer end surface SC1 of the first spacer 4a and a portion of the first lateral surface B1 of the capacitor main body 1A (multilayer body 2), and another portion covering the middle-side spacer end surface SC1 of the second spacer 4b and a portion of the first lateral surface B1 of the capacitor main body 1A (multilayer body 2).

As shown in FIG. 3, in an example embodiment of the present invention, when the area of the spacer 4 at the middle-side spacer end surface SC1 (the area enclosed by the bold line in FIG. 3) is defined as X0, and the area of the reinforcement portion 5 at the middle-side spacer end surface SC1 (the area indicated by the hatched region in FIG. 3) is defined as X1, it is preferable that X1 is, for example, about 50% or more of X0. That is, it is preferable that the reinforcement portion 5 covers, for example, about 50% or more of the area of the middle-side spacer end surface SC1 of each spacer 4.

Thus, for example, since the reinforcement portion 5 is fixed to each of the spacers 4 over about 50% or more of the area of the middle-side spacer end surface SC1, the reinforcement portion 5 can be fixed to each of the spacers 4 with a strong force.

Also, as shown in FIGS. 2 and 3, in an example embodiment of the present invention, the length (thickness) Tc in the lamination direction T of the reinforcement portion 5 at the portion connected to each of the spacers 4 is preferably thicker than the length (thickness) Im in the lamination direction T of the reinforcement portion 5 at the approximate middle portion in the length direction L between the two spacers 4, i.e. Tm<Tc. If Tm<Tc, when viewed from one side in the width direction W, the reinforcement portion 5 may have an arch shape in which the thickness smoothly decreases from the portion with thickness Tc connected to each of the spacers 4 to the portion with thickness Tm at the middle portion. Also, the reinforcement portion 5 may have a U-shaped cross-section in which the thickness changes abruptly from the portion with thickness Tc connected to each of the spacers 4 to the portion with thickness Tm at the middle portion. In this way, since the middle portion of the reinforcement portion 5 in the length direction is recessed according to the relationship of Im<Tc, the possibility of contact between the substrate and the reinforcement portion 5 is reduced even when distorted.

Also, in an example embodiment of the present invention, as shown in FIGS. 2 and 4, when viewed in a cross-section passing through the length direction L and the lamination direction T, the respective spacers 4 do not protrude from the external electrode 3 toward the middle in the length direction L. That is, the entire or substantially the entire area of the second main surface A2 of the multilayer body 2 that is exposed in the capacitor main body 1A is covered with the reinforcement portion 5. Therefore, it is possible to maximize the bonding strength between the reinforcement portion 5 and the multilayer body 2.

In a case different from the present example embodiment, when viewed in a plane passing through the length direction L and the lamination direction T, if each of the spacers 4 protrudes from the external electrode 3 toward the middle in the length direction L, and there is a gap between the spacer 4 and the portion of the second main surface A2 of the multilayer body 2 where the external electrode 3 is not provided, the reinforcement portion 5 may be provided to enter into that gap. Since the bonding area between the reinforcement portion 5 and the spacer 4 increases by entering into the gap, the bonding strength increases. In addition, when the gap is not completely filled by the reinforcement portion 5, it is possible to mitigate the propagation of vibration by the gap.

Also, it is preferable that the surface roughness Sa of each of the spacers 4 is, for example, about 0.3 μm or more. By setting the surface roughness Sa of each of the spacers 4 to about 0.3 μm or more, it is possible to increase the bonding strength between the spacer 4 and the reinforcement portion 5 due to the anchor effect. However, if the surface roughness is too large, the fillet by the reinforcement portion 5 will not rise sufficiently, so it is preferable that it is, for example, about 7.0 μm or less.

### Measurement Method

The measurement of the length (thickness) of the reinforcement portion 5 in the lamination direction T described above can be performed, for example, as follows. In a case where the multilayer ceramic capacitor 1 is bonded to a wiring board with solder, the multilayer ceramic capacitor 1 bonded to the wiring board with solder is polished in the width direction W until a position on the LT cross-section where the multilayer ceramic capacitor 1 and the reinforcement portion 5 are visible. Then, using an Axio (registered trademark) Imager MAT, manufactured by ZEIS, the length of the reinforcement portion 5 in the lamination direction T is measured with an appropriate magnification such as, for example, about 100 times to about 500 times.

### Method of Manufacturing Multilayer Ceramic Capacitor 1

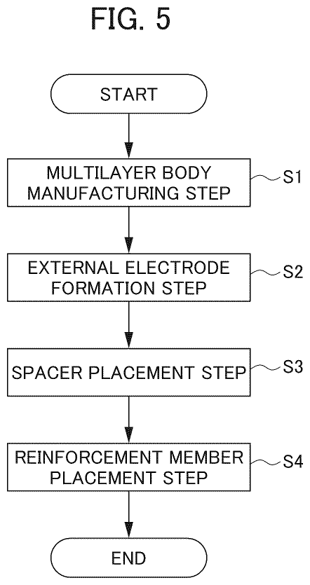

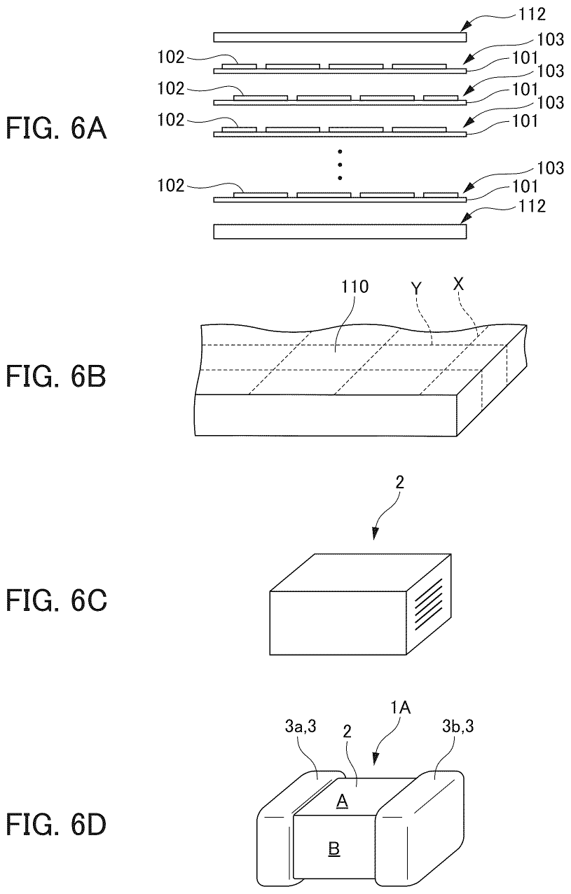

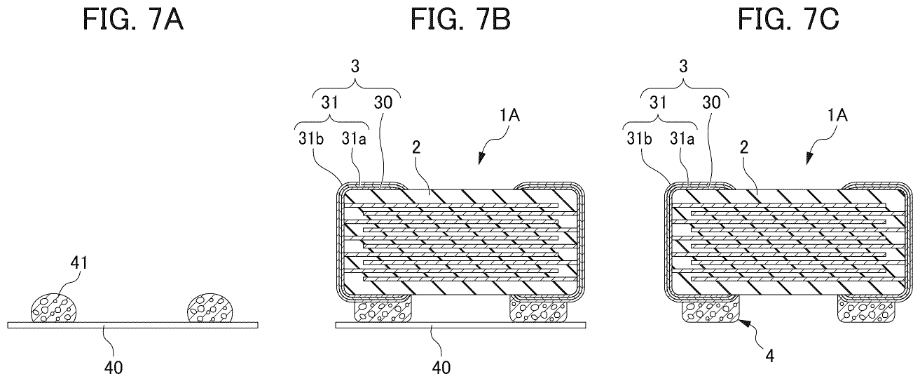

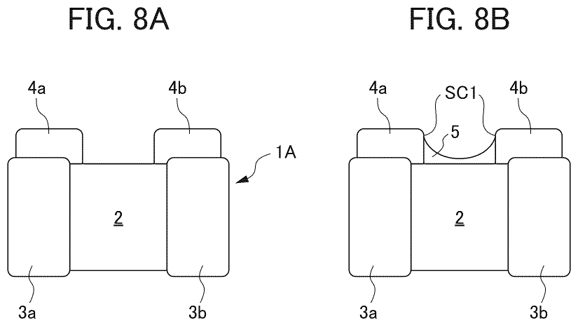

FIG. 5 is a flowchart explaining an example of a method of manufacturing the multilayer ceramic capacitor 1 according to an example embodiment of the present invention. The method of manufacturing the multilayer ceramic capacitor 1 includes a multilayer body manufacturing step S1, an external electrode formation step S2, a spacer placement step S3, and a reinforcement portion placement step S4. FIGS. 6A to 6D are diagrams explaining the multilayer body manufacturing step S1 and the external electrode formation step S2. FIGS. 7A to 7C are diagrams explaining the spacer placement step S3. FIGS. 8A and 8B are diagrams explaining the reinforcement portion placement step S4.

### Multilayer Body Manufacturing Step S1

A ceramic slurry including ceramic powder, binder, and solvent is formed into a sheet on the surface of a carrier film using, for example, a die coater, gravure coater, micro gravure coater, etc., to create a multilayer ceramic green sheet 101 that defines and functions as the dielectric layer 14. Next, a material sheet 103 is created by printing an electrically conductive paste in a strip pattern on the multilayer ceramic green sheet 101 by, for example, screen printing, inkjet printing, gravure printing, etc., and printing an electrically conductive pattern 102 that defines and functions as the internal electrode layer 15 on the surface of the multilayer ceramic green sheet 101.

Next, as shown in FIG. 6A, a plurality of material sheets 103 are stacked such that the electrically conductive patterns 102 face in the same direction and the electrically conductive patterns 102 are offset from each other by, for example, about half a pitch in the length direction L between adjacent material sheets 103. Furthermore, ceramic green sheets 112 for outer layer portions, which define and function as the outer layer portions 12, are stacked on both sides of the plurality of stacked material sheets 103.

The plurality of stacked material sheets 103 and the ceramic green sheets 112 for outer layer portions are pressed together using, for example, a hydrostatic press or the like to create a mother block 110 as shown in FIG. 6B.

Next, the mother block 110 is cut along cutting lines X and cutting lines Y that intersect the cutting lines X as shown in FIG. 6B to manufacture a plurality of multilayer bodies 2 as shown in FIG. 6C.

### External Electrode Formation Step S2

Next, a base electrode layer 30 is formed by, for example, applying and firing an electrically conductive paste including copper (Cu) to the end surfaces C of the multilayer body 2. The base electrode layer 30 extends not only on both end surfaces C of the multilayer body 2, but also to the main surfaces A and lateral surfaces B of the multilayer body 2, so as to cover a portion of the main surfaces A adjacent to the end surfaces C.

Then, a plated layer 31 is formed on the surface of the base electrode layer 30, including, for example, a nickel (Ni) plated layer 31a and a tin (Sn) plated layer 31b provided on the surface of the nickel (Ni) plated layer 31a, to manufacture a capacitor main body 1A as shown in FIG. 6D.

### Spacer Placement Step S3

A spacer manufacturing paste 41 for manufacturing spacers is prepared.

The spacer manufacturing paste 41 includes metals such as, for example, copper (Cu), nickel (Ni), tin (Sn), and silver (Ag), phenol resin, solvent, and additives. In this case, for example, rosin may be included instead of phenol resin.

Examples of the phenol resin include novolac-type phenol resins such as a phenol novolac resin, phenol aralkyl resin, cresol novolac resin, tert-butylphenol novolac resin, or nonylphenol novolac resin, resol-type phenol resins, or polyoxystyrene such as polyparaoxystyrene.

FIGS. 7A to 7C are diagrams explaining the spacer placement step S3. As shown in FIG. 7A, first, the spacer manufacturing paste 41 is provided on a holding substrate 40 by, for example, a screen printing method, a dispensing method or the like.

Next, as shown in FIG. 7B, the capacitor main body 1A is mounted on the upper surface of the holding substrate 40 in a posture where the second main surface A2 is opposed to the holding substrate 40. At this time, the external electrode 3 of the capacitor main body 1A is aligned with the spacer manufacturing paste 41, and the spacer manufacturing paste 41 adheres to the capacitor main body 1A.

In this state, a heating step is performed. When at least a portion of the metal in the paste forms an intermetallic compound to form a metal region MP, a portion of the phenol resin is incorporated into the metal region MP, while a portion thereof is discharged from the metal region MP, and the metal region MP is cured, such that a spacer 4 bonded to the capacitor main body 1A is formed.

In the above, a configuration including an intermetallic compound and phenol resin is shown as an example of the spacer material, but is not limited thereto, and, for example, it may include different types of metal components, or it may include resins other than the phenol resin such as an epoxy resin or rosin, and/or a glass component. Also, it may be formed without including resin.

Subsequently, as shown in FIG. 7C, the capacitor main body 1A, together with the spacer 4, is separated from the holding substrate 40. The present invention is not limited to this manufacturing method, and it is also possible to directly place the spacer manufacturing paste in a desired shape on the surface of the capacitor main body 1A, and perform heat treatment to form the spacer.

### Reinforcement Portion Placement Step S4

FIGS. 8A and 8B are diagrams explaining the reinforcement portion placement step S4. First, the surface of the capacitor main body 1A on which the spacers 4 are provided is cleaned with a solvent. As shown in FIG. 8A, after the cleaning is completed, the capacitor main body 1A with the spacers 4 is aligned so that the spacers 4 face upward.

Next, as shown in FIG. 8B, an insulating resin layer defining and functioning as a reinforcement portion 5 is formed between the first spacer 4a and the second spacer 4b on the capacitor main body 1A with the spacers 4, using, for example, a dispenser or squeegee printing. The amount of spreading onto the middle-side spacer end surface SC1 can be varied by changing the amount of insulating resin.

To cause the insulating resin to penetrate into the interface between the spacer 4 and the multilayer body 2, it is possible to perform, for example, vacuum drawing after placing the insulating resin. The amount of penetration can be controlled by changing the time and pressure of the vacuum drawing. The multilayer ceramic capacitor 1 of the above-described example embodiment is manufactured through the above steps.

According to the multilayer ceramic capacitor 1 of an example embodiment, since the spacers 4 are attached to the capacitor main body 1A, it is possible to buffer the vibration generated in the capacitor main body 1A by the spacer 4, and it is possible to reduce or prevent the vibration transmitted to the mounting substrate.

Further, according to the multilayer ceramic capacitor 1 of the present example embodiment, the reinforcement portion 5 is attached between the spacers 4. Therefore, it is possible to strengthen the bonding strength between the capacitor main body 1A and the spacers 4, such that it is possible to prevent the spacers 4 from peeling off from the capacitor main body 1A. Furthermore, the resistance to the occurrence of cracks generating in the multilayer ceramic capacitor 1 when bending or the like occurs in the mounting substrate, that is, the substrate bending resistance, is improved.

Since the reinforcement portion 5 covers, for example, about 50% or more of the middle-side spacer end surface SC1 of each of the two spacers 4, it is possible to ensure a high bonding strength between the reinforcement portion 5 and the spacer 4.

By forming the reinforcement portion 5 with an insulating resin, it is possible to improve the strength against deflection, and by coating it with a water-repellent treatment agent, it is possible to improve moisture resistance.

Since the surface roughness at a bonding portion with the reinforcement portion 5 of each of the spacers 4 is, for example, about 0.3 μm or more, it is possible to increase the bonding strength between each of the spacers 4 and the reinforcement portion 5 by the anchor effect.

The thickness Tc in the lamination direction T of the reinforcement portion 5 at the middle-side spacer end surface SC1 connected to each of the spacers 4 and the thickness Tm in the lamination direction T of the reinforcement portion 5 at the middle portion in the length direction L between the two spacers 4 satisfy the relationship of Tm<Tc. Therefore, with such a configuration, since the middle portion of the reinforcement portion 5 in the length direction is recessed, the possibility of contact between the mounting substrate and the reinforcement portion 5 is reduced even when the multilayer ceramic capacitor 1 is distorted.

In a case where a gap is provided between the spacers 4 and the second main surface A2 of the multilayer body 2, it is preferable to provide a reinforcement portion 5 in the gap. In this case, when the reinforcement portion 5 enters into the gap, the bonding area between the reinforcement portion 5 and the spacer 4 increases, such that it is possible to strengthen the bonding strength. On the other hand, in a case where the gap is not completely filled with the reinforcement portion 5, it is possible to mitigate the propagation of vibration by the gap.

Although example embodiments of the present invention have been described above, the present invention is not limited to the example embodiments, and can be provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor main body including a multilayer body including dielectric layers and internal electrode layers laminated, two main surfaces opposed to each other in a lamination direction, two end surfaces opposed to each other in a length direction intersecting the lamination direction, and two lateral surfaces opposed to each other in a width direction intersecting the lamination direction and the length direction; and
two external electrodes each on a corresponding one of the two end surfaces, each connected to the internal electrode layers, and each extending to the two main surfaces and the two lateral surfaces to cover a portion of each of the two main surfaces and a portion of each of the two lateral surfaces;
two spacers on one of the two main surfaces of the capacitor main body, being located respectively adjacent to one of the two end surfaces and adjacent to one other of the two end surfaces with a corresponding one of the two external electrodes respectively covering the portion of each of the two main surfaces, interposed between the capacitor main body and a corresponding one of the two spacers; and
a reinforcement portion between the two spacers; wherein
the reinforcement portion covers about 50% or more of middle-side spacer end surfaces of the two spacers that are opposed to each other between the two spacers, among two spacer end surfaces opposed to each other in the length direction in each of the two spacers.

2. The multilayer ceramic electronic component according to claim 1, wherein the reinforcement portion includes an insulating resin.

3. The multilayer ceramic electronic component according to claim 1, wherein the reinforcement portion is continuously provided in the length direction.

4. The multilayer ceramic electronic component according to claim 1, wherein a surface roughness at a bonding portion of each of the two spacers with the reinforcement portion is about 0.3 μm or more.

5. The multilayer ceramic electronic component according to claim 1, wherein a thickness Im of the reinforcement portion in the lamination direction at a portion connected to each of the two spacers and a thickness Tc of the reinforcement portion in the lamination direction at a middle portion of the reinforcement portion in the length direction L between the two spacers satisfy a relationship of Tm<Tc.

6. The multilayer ceramic electronic component according to claim 1, wherein a gap is provided between each of the two spacers and one of the two main surfaces of the multilayer body, and the reinforcement portion is provided in the gap.

7. The multilayer ceramic electronic component according to claim 3, wherein a thickness Im of the reinforcement portion in the lamination direction at a portion connected to each of the two spacers and a thickness Tc of the reinforcement portion in the lamination direction at a middle portion of the reinforcement portion in the length direction L between the two spacers satisfy a relationship of Tm<Tc.

8. The multilayer ceramic electronic component according to claim 1, wherein a surface roughness at a bonding portion of each of the two spacers with the reinforcement portion is about 7.0 μm or less.

9. The multilayer ceramic electronic component according to claim 4, wherein a surface roughness at a bonding portion of each of the two spacers with the reinforcement portion is about 7.0 μm or less.

10. The multilayer ceramic electronic component according to claim 1, wherein a length of each of the spacers in the length direction is greater than a corresponding one of the external electrodes.

11. The multilayer ceramic electronic component according to claim 1, wherein each of the spacers includes copper or nickel as a metal powder, and tin.

12. The multilayer ceramic electronic component according to claim 11, wherein the metal powder is coated with silver.

13. The multilayer ceramic electronic component according to claim 1, wherein each of the spacers includes an intermetallic compound including tin added to copper or nickel.

14. The multilayer ceramic electronic component according to claim 1, wherein each of the spacers includes an intermetallic compound including tin added to an alloy of copper and nickel.

15. The multilayer ceramic electronic component according to claim 11, wherein the metal powder include phenol resin.

16. The multilayer ceramic electronic component according to claim 15, wherein an area ratio of the phenol resin in each of the spacers is about 1% or more and about 20% or less.

17. The multilayer ceramic electronic component according to claim 15, wherein an area ratio of the phenol resin in each of the spacers is about 5% or more and about 15% or less.

18. The multilayer ceramic electronic component according to claim 1, wherein each of the spacers has a void ratio of about 20% or less in a region within about 5 μm from an interface with a corresponding one of the external electrodes.
